(19) United States
(12) Patent Application Publication
(10) Pub. No.: US 2023/0147367 A1
(43) Pub. Date: May 11, 2023

(54) FIBER OPTIC CONNECTOR WITH INTERLOCKING CRIMP SLEEVE

(71) Applicant: COMMSCOPE TECHNOLOGIES LLC, Hickory, NC (US)

(72) Inventor: Adam Verne BROUGHTON, Harrisburg, PA (US)

(73) Assignee: COMMSCOPE TECHNOLOGIES LLC, Hickory, NC (US)

(21) Appl. No.: 17/917,893

(22) PCT Filed: Apr. 7, 2021
(86) PCT No.: PCT/US2021/026260

§ 371 Date: Oct. 7, 2022

Related U.S. Application Data
(60) Provisional application No. 63/006,829, filed on Apr. 8, 2020.

(51) Int. Cl. G02B 6/38

(52) U.S. Cl. CPC G02B 6/3857; G02B 6/3887

(57) ABSTRACT

A fiber optic connector has a plug region at a first axial end and an anchor region at a second axial end. The anchor region includes first interlock members which protrude outwardly from a support portion. A crimp sleeve can be disposed over the anchor region of the plug connector so that a surrounding portion (e.g., a jacket and/or strength members) of the cable extends between the crimp sleeve and the first interlock members. When the plug connector is assembled, second interlock members can be formed in the crimp sleeve to extend radially into gaps between the first interlock members to enhance retention of the surrounding portion of the cable therebetween.

### CROSS-REFERENCE TO RELATED APPLICATION

This application is being filed on Apr. 7, 2021 as a PCT International Patent Application and claims the benefit of U.S. Patent Application Ser. No. 63/006,829, filed on Apr. 8, 2020, the disclosure of which is incorporated herein by reference in its entirety.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors allow two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A fiber optic connector is often secured to the end of a corresponding fiber optic cable by anchoring strength numbers of the cable to the connector housing of the connector. Anchoring is typically accomplished through the use of conventional techniques such as crimps or adhesive. Anchoring the strength numbers of the cable to the connector housing is advantageous because it allows tensile load applied to the cable to be transferred from the strength members of the cable directly to the connector housing. Improvements are desired.

### SUMMARY

One aspect of the disclosure relates to a plug connector configured to terminate an end of a cable. The plug connector extends along a longitudinal axis between opposite first and second axial ends. The plug connector defines a plug region at the first axial end and an anchor region at the second axial end. One or more carrying members (e.g., optical fiber, conductive wire, etc.) of the cable pass through the plug connector from the anchor region to the plug region. A surrounding portion of the cable (e.g., a jacket, a buffer tube, and/or one or more strength members (e.g., aramid yarn, reinforcing rods, etc.) attaches to the plug connector at the anchor region.

In certain implementations, the anchor region of the connector includes a support portion and a series of first interlock members which protrude outwardly from the support portion. A crimp sleeve can be disposed over the anchor region of the plug connector so that the surrounding portion of the cable extends between the crimp sleeve and the first interlock members. When the plug connector is assembled, the crimp sleeve can include second interlock members extending radially into gaps between the first interlock members to sandwich the surrounding portion of the cable therebetween.

In certain examples, each of the second interlock members of the crimp sleeve extends along a majority of an axial length of respective one of the gaps. In certain examples, the crimp sleeve has an exterior surface in which each of the second interlock members define respective depressions each having a rectangular cross dimension.

In certain examples, each of the first interlock members of the plug includes an outer surface facing radially outwardly from the support portion, a first transition surface extending between the support portion and one axial end of the outer surface, and a second transition surface extending between the support portion and the other axial end of the outer surface. In an example, the first and second transition surfaces are perpendicular to the longitudinal axis. In an example, the outer surface of a first interlock member has a common transverse cross-dimension along the axial length of the outer surface. In an example, each of the outer surface, the first transition surface, and the second transition surface engages the surrounding portion of the cable to induce friction therebetween.

In accordance with certain aspects of the disclosure, a plug connector manufacturing system includes a die set configured to install the crimp sleeve on the plug connector to anchor the cable to the plug connector. The die set is configured to form the second interlock members of the crimp sleeve to enhance retention of the surrounding portion of the cable between the crimp sleeve and the anchor end of the plug connector. The die set includes one or more forming members that align with gaps between the first interlock members of the plug connector when the plug connector is loaded onto the die set. The forming members create the second interlock members of the crimp sleeve.

The die set includes first and second bodies that are selectively movable between actuated and non-actuated positions. The first and second bodies cooperate to define a crimp station when the first and second bodies are in the actuated position. The first body defines an alignment stop against which the anchor end of the connector body abuts when the connector body is mounted to the die set to align the plug connector within the die set.

The forming members are disposed within the crimp station. In certain examples, the forming members extend along a majority of an axial length of the respective gap. In certain examples, the forming members have flat surfaces facing towards the crimp sleeve. In some examples, the forming members are disposed at one of the first and second bodies. In other examples, the forming members are disposed at both of the first and second bodies.

In certain implementations, the anchor end of the plug connector defines a strength member retention section and a jacket retention section. The jacket retention section is disposed between the strength member retention section and an axial end of the plug connector. the support portion of the anchor end has a reduced transverse cross-section at the jacket retention section compared to the transverse cross-section at the strength member retention section. Strength members of the cable extend over the axial end of the plug connector, over the jacket retention section, and over the strength member retention section. The jacket of the cable extends over the axial end and over the jacket retention section. The jacket terminates without extending over the strength member retention section of the support portion.

In certain implementations, the plug connector includes a plug body and a rear body. The plug body defines the plug end of the plug connector and the rear body defines the anchor end of the plug connector. In certain examples, the rear body snap-fits to the plug body. In certain examples, a spring is disposed between the plug body and the rear body to bias the carrying member (e.g., to bias a ferrule holding an optical fiber) towards the plug end of the plug connector.

Another aspect of the present disclosure relates to a method of terminating a cable at a plug connector. The cable can include a carrying member surrounded by a jacket. In certain examples, the cable also can include strength members disposed within the jacket. In certain examples, the plug connector can include a plug body and a rear body.

One aspect of the method includes positioning the cable at an anchor region of the plug connector; positioning a crimp sleeve over the cable at the anchor region; positioning the plug connector, the cable, and the crimp sleeve at a die set so that the anchor region aligns with a crimp station of the die set; and installing the crimp sleeve at the anchor region using the die set.

In certain implementations, the die set includes one or more forming members at the crimp station. Accordingly, installing the crimp sleeve includes compressing the crimp sleeve with at least the forming members to form second interlock members of the crimp sleeve.

In certain implementations, positioning the cable at the anchor region includes routing a carrying member through a passage defined through the plug connector to a plug region and routing a surrounding portion of the cable over an exterior of the anchor region so that the surrounding portion extends across a series of first interlock members protruding radially outwardly from the exterior of the anchor region. In certain examples, the surrounding portion of the cable includes a jacket and strength members. In some such examples, routing the surrounding portion of the cable over the exterior of the anchor region includes routing the strength members over a majority of the anchor region and routing the jacket over less of the anchor region than the strength members.

In certain implementations, positioning the plug connector and the crimp sleeve at the die set includes aligning an edge of the crimp sleeve and the axial end of the plug connector at a stop surface defined by the die set to align the crimp sleeve and anchor section with the forming members of the die set. In certain implementations, the plug connector includes a plug body that connects to a rear body, which defines the anchor region. In some such implementations, the plug body and the rear body are connected together when the anchor region is positioned at the crimping station. In other such implementations, the rear body is separate from the plug body when the anchor station and crimp sleeve are disposed at the crimping station.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an example cable assembly including an example cable anchored to an example plug connector using a crimp sleeve in accordance with the principles of the present disclosure.

FIG. 2 is a perspective view of the plug connector of FIG. 1, which extends along a longitudinal axis between an anchor region and a plug region.

FIG. 3 is a cross sectional view of the plug connector of FIG. 1 taken along the longitudinal axis of the plug connector.

FIG. 4 is a top perspective view of an example die set with a first body of the die set shown exploded from a second body of the die set so that a portion of the crimping station is visible.

FIG. 5 is an enlarged view of the portion of the crimping station of FIG. 4.

FIG. 6 is a bottom perspective view of the die set of FIG. 4 in which another portion of the crimping station is visible.

FIG. 7 is an enlarged view of the other portion of the crimping station of FIG. 6.

FIG. 8 is a perspective view of the cable assembly of FIG. 2 disposed at a crimping station of a die set, with the crimp sleeve shown uncompressed, and with a portion of the die set being removed for ease in viewing.

FIG. 9 shows the plug connector and partial die set of FIG. 8 with the cable removed for ease in viewing the second axial ends of the plug connector and crimp sleeves.

FIG. 10 shows an example implementation of the anchor region suitable for use with the plug connector of FIG. 1.

FIG. 11 is an exploded view of an example implementation of the plug connector of FIG. 1 including a plug body and a rear body.

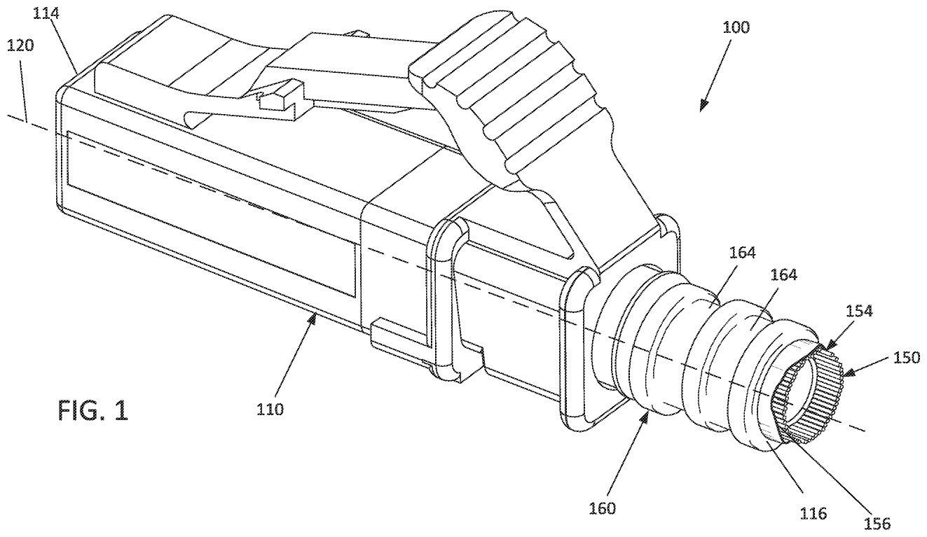

### DETAILED DESCRIPTION

Various examples will be described in detail with reference to the drawings, wherein like reference numerals represent like parts and assemblies throughout the several views. Wherever possible, the same reference numbers will be used throughout the drawings to refer to the same or like parts. Reference to various examples does not limit the scope of the claims attached hereto. Additionally, any examples set forth in this specification are not intended to be limiting and merely set forth some of the many possible examples for the appended claims.

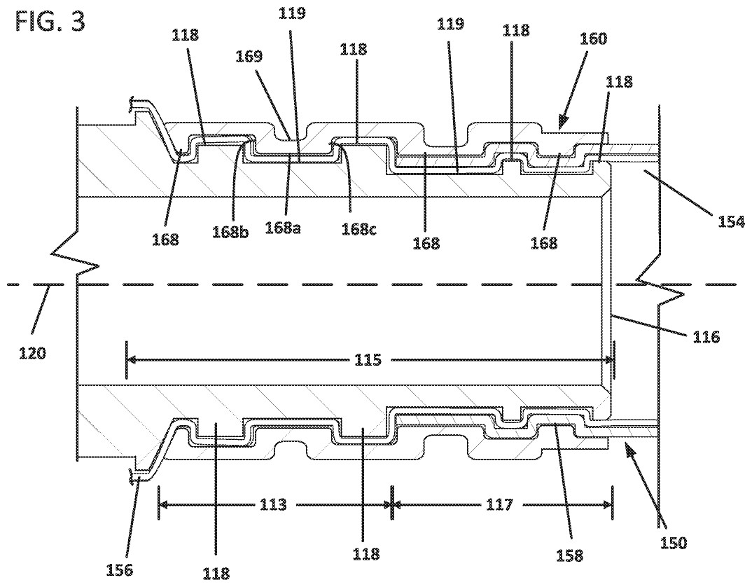

The present disclosure relates to a connectorized cable assembly 100 including a plug connector 110 terminating a cable 150. The plug connector 110 extends along a longitudinal axis 120 between opposite first and second axial ends 114, 116 of the plug connector 110. The cable 150 includes at least one carrying member (e.g., an optical fiber, a conductive wire, etc.) disposed within a surrounding portion 154 (e.g., a jacket, strength members, a buffer tube, etc.). The cable 150 is routed to the second axial end 116 of the plug connector 110. The carrying member extends through a passage 111 (FIG. 3) defined by the plug connector 110 towards the first axial end 114 of the plug connector 110. The surrounding portion 154 of the cable 150 is attached to the plug connector 110 at the second axial end 116.

In certain implementations, the plug connector 110 includes a plug region 111 at the first axial end 114 and an anchor region 115 at the second axial end 116. The plug region 111 is configured to be received within a receptacle (e.g., adapter port, electrical socket, etc.). The surrounding portion 154 of the cable 150 is disposed about the anchor region 115 of the plug connector 110. A crimp sleeve 160 is disposed over the surrounding portion 154 of the cable 150 at the anchor region 115. The surrounding portion 154 is sandwiched between first interlocking members 118 of the plug connector 110 and second interlocking members 168 of the crimp sleeve 160 to retain the surrounding portion 154 at the plug connector 110 (e.g., see FIG. 3).

In certain implementations, the surrounding portion 154 of the cable 150 includes a jacket 158 surrounding the one or more carrying members. In certain implementations, the surrounding portion 154 includes one or more strength members 156 (e.g., aramid yarn, fiberglass rods, etc.) disposed within the jacket 158. In some examples, the strength members 156 are disposed between the carrying member and the jacket 158. In other examples, the strength members 156 are embedded within the jacket 158. In certain implementations, the surrounding portion 154 includes a buffer tube or intermediate jacket.

In some implementations, the carrying member includes an optical fiber. In some such implementations, the optical fiber is held by an optical ferrule at the plug region 111 of the plug connector 110. In other such implementations, the plug connector 110 is ferruleless. In other implementations, the carrying member includes a conductive wire. In some such implementations, the conductive wire extends to a termination contact (e.g., a spring contact, an insulation displacement contact, etc.) at the plug region 111 of the plug connector 110. In certain implementations, the cable 150 includes a plurality of carrying members extending through the surrounding portion 154.

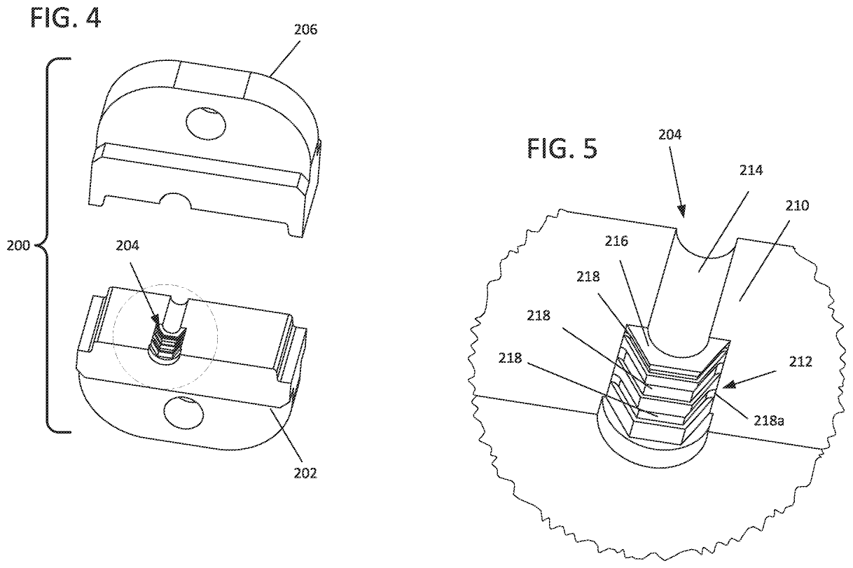

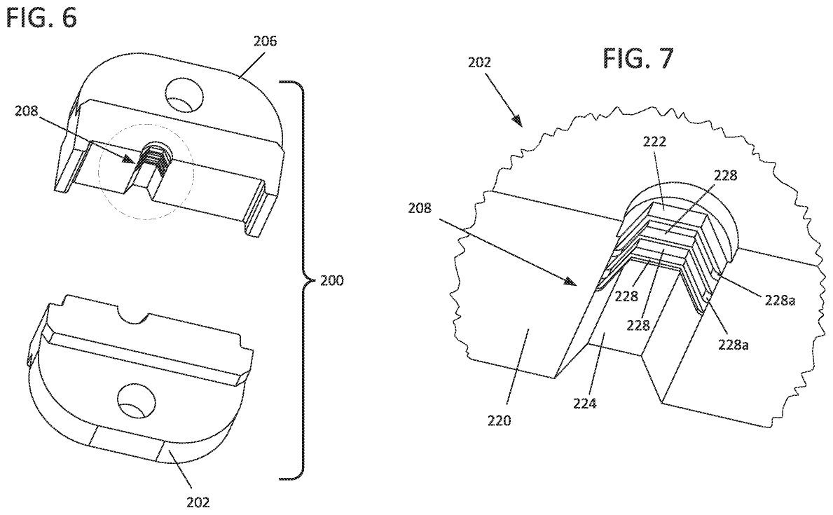

To secure the surrounding portion 154 of the cable 150 to the plug connector 110, the crimp sleeve 160 is radially compressed over the anchor region 115 of the plug connector 110 and the surrounding portion 154 of the cable 150 using a die set 200 (e.g., see FIGS. 4 and 6). Once the crimp sleeve 160 is crimped using the die set 200, the strength members 156 and cable jacket 158 are secured in place (e.g., through friction).

As shown, the die set 200 includes a crimping station having forming members 218, 228 that press into the crimp sleeve 160 to form the second interlock member 168. In certain implementations, the forming members 218, 228 align with gaps 119 extending along the longitudinal axis 120 between the first interlock members 118 when the plug connector 110 and crimp sleeve 160 are mounted at the die set 200. Accordingly, when pressure is applied to the die set 200, the forming members 218, 228 deform the portions of the crimp sleeve 160 radially aligned with the gaps 119 towards the gaps 119 to form the second interlock members 168 (e.g., see FIG. 3). In certain examples, the forming members 218, 228 leave a recesses 219 that face radially outwardly from the crimp sleeve 160.

In some implementations, the forming members 218, 228 include one or more raised ribs that extend laterally across the crimping station (e.g., see FIGS. 5 and 7). In such implementations, the second interlock members 168 include circumferential protrusions extending radially inwardly towards the anchor region 115 of the plug connector 110. In some examples, the circumferential protrusions are ring shaped (e.g., have a circular transverse cross-sectional profile). In other examples, the circumferential protrusions have a series of flat surfaces to form a polygonal shape (e.g., having a hexagonal transverse cross-sectional profile, a pentagonal transverse cross-sectional profile, or an octagonal transverse cross-sectional profile). In other implementations, the forming members 218, 228 include a series of shorter ribs arranged in one or more rows that extend laterally across the crimping station. In such implementations, the shorter ribs dimple the crimp sleeve 160 in circumferential rows to form the second interlock members 168.

As shown in FIGS. 4-7, an example die set 200 includes separate first and second pieces 202, 206 that are movable between a loading configuration and a pressing configuration. Each of the pieces 202, 206 defines a respective cable station 206, 208. When in the loading configuration, the cable stations 204, 208 are accessible to a user. When in the pressing configuration, the cable stations 204, 208 are aligned opposite each other. Each cable station 204, 208 is recessed into a surface 210, 220 of the respective die piece 202, 204 that faces the other die piece 204, 202. Each cable station 204, 208 includes a crimp region 212, 222 at which the forming members 218, 228 are disposed. Each cable station 204, 208 also includes a cable channel 214, 224 through which the cable 150 extends away from the crimp sleeve 160 and connector 110. In certain implementations, forming members 218, 228 are not disposed in the cable channel 214, 224.

In certain implementations, the forming members 218, 228 include ribs having outer surfaces facing towards the anchor region 115 when the plug connector 110 is mounted at the cable station 204, 208. In certain examples, the outer surfaces extend parallel to the longitudinal axis 120. In certain examples, the ribs 218, 228 form continuous half rings laterally across the crimp regions 212, 222. In certain examples, the ribs 218, 228 include multiple sections having flat outer surfaces (e.g., see FIGS. 5 and 7).

In certain implementations, the edges 218a, 2228a of the ribs 218, 228 are recessed into the cable channel 214, 224 from the surface 210, 220 of the respective die set piece 202, 204. Recessing the edges 218a, 228a may inhibit pinching or crimping of the sleeve 160 between the ribs 218, 228. In certain examples, edges 218a, 228a of the ribs 218, 228, whether recessed or not, are contoured or angled so that the ribs 218, 228 do not pinch the crimp sleeve 160 therebetween when the die set pieces 202, 204 are pressed together. For example, the edges 218a, 228a of each rib 218, 228 extend away from the surface 210, 220 of the respective die set piece 202, 204.

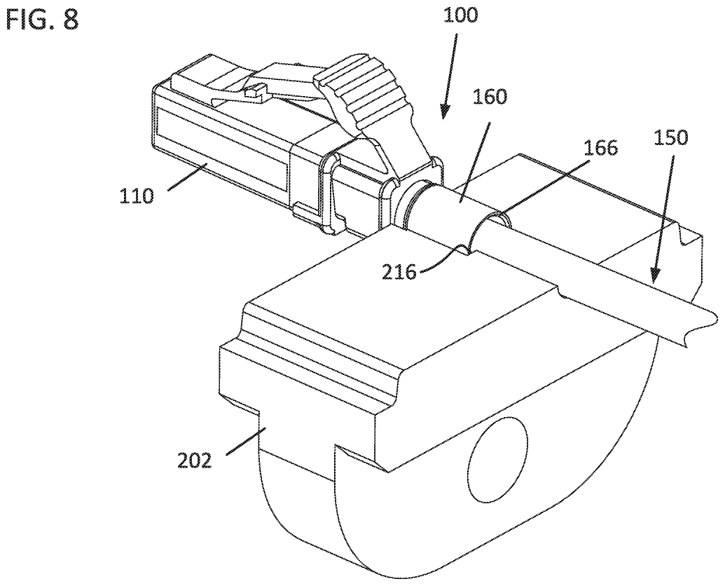

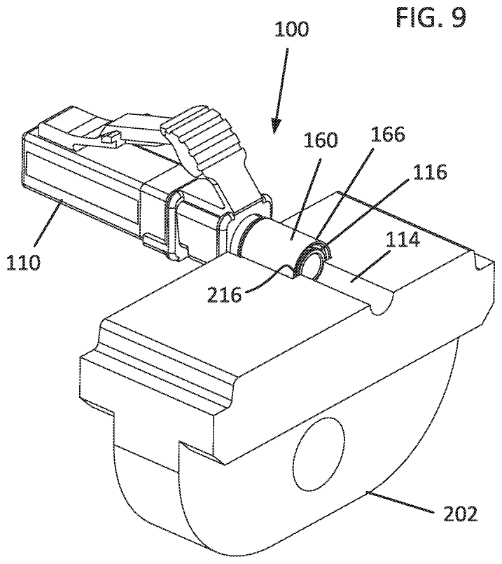

In certain implementations, the cable station 204, 208 of at least one of the die pieces 202, 206 includes an alignment stop 216 configured to longitudinally align the anchor region 115 and crimp sleeve 160 at the crimp region 212, 222. In certain examples, the alignment stop 216 includes a surface against which the second axial end 116 of the plug connector 110 abuts when properly loaded within the recessed cable station 204 (e.g., see FIG. 9). When the second axial end 116 of the plug connector 110 abuts the alignment stop 216, the forming members 218, 228 properly align with the gaps 119 between the first interlock members 118. In certain examples, an axial end 166 of the crimp sleeve 160 also abuts the surface 216 (e.g., see FIGS. 8 and 9).

In some implementations, the cable stations 204, 208 of the die set pieces 202, 206 are mirror images of each other. In other implementations, the cable station 204 of the first piece 202 is configured to receive the plug connector 110, crimp sleeve 160, and cable 150 before the second piece 204 is moved to the pressing configuration. Accordingly, the crimp region 212 of the cable station 204 is deeper (i.e., has a larger transverse cross-section) than the cable channel 214 to better accommodate the anchor region 115 and crimp sleeve 160 (see FIGS. 5 and 9). In certain implementations, the crimp region 222 of the cable station 208 has a similar or the same transverse cross-section to the cable channel 224.

In certain implementations, at least the crimp regions 212, 222 of the cable stations 204, 208 have polygonal transverse cross-sectional shapes that cooperate to define a hexagonally-shaped transverse cross-sectional profile of the crimp station. In certain examples, the forming members 218, 228 of the die set pieces 202, 204 also cooperate to define hexagon transverse cross-sectional shapes. In certain examples, the cable channel 224 of at least one of the die pieces 202, 204 has a polygonal transverse cross-sectional shape that matches the polygonal transverse cross-sectional shape of the crimp region 222 (see FIG. 7). In some examples, both of the cable channels 214, 224 have a common transverse cross-sectional shape. In other examples, the cable channel 214 of the first die piece 202 is curved (see FIG. 5).

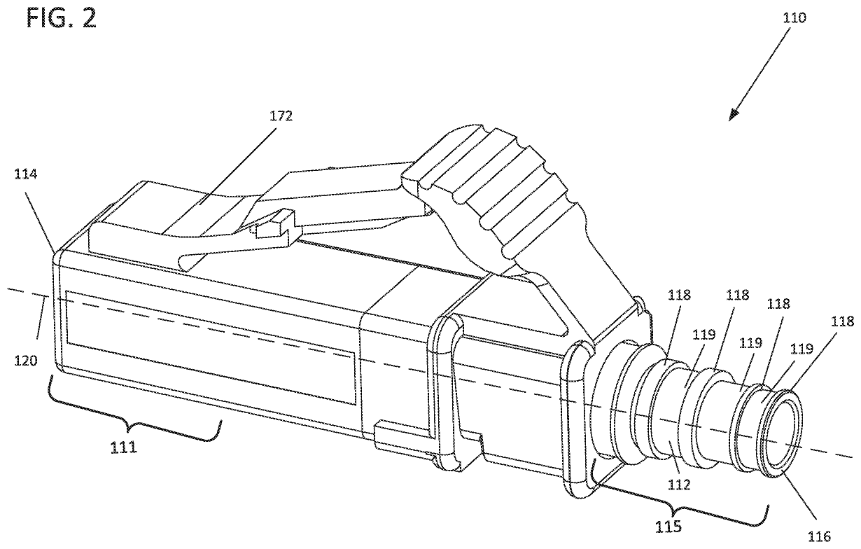

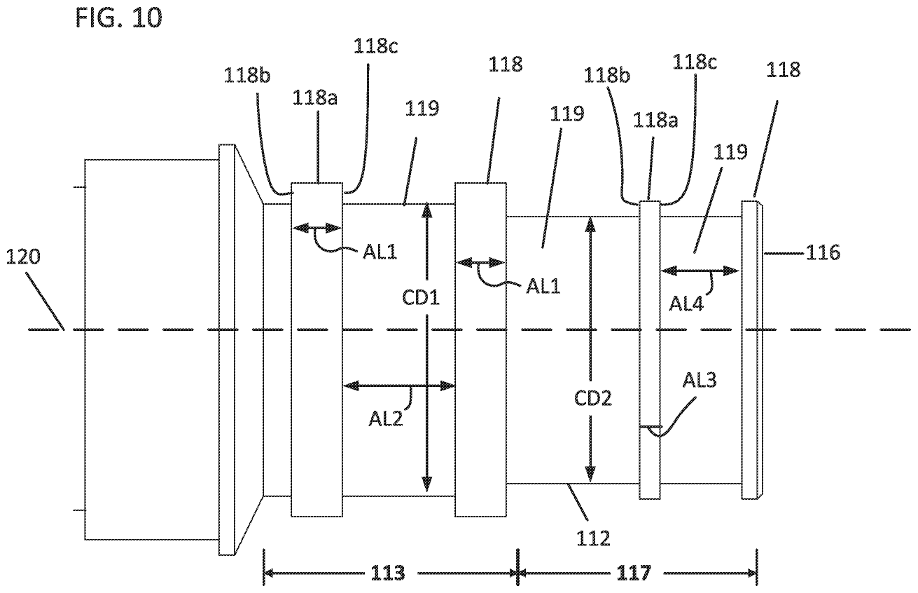

Referring to FIGS. 2 and 10, an example plug connector 110 includes a support portion 112 at the anchor region 115. The first interlock members 118 protrude outwardly from the support portion 112. In certain examples, the support portion 112 forms the innermost surface of the gaps 119 between the interlock members 118. The support portion 112 is sufficiently strong to enable the crimp sleeve 160 to deformed thereon without crushing the carrying member of the cable 150 that extends therethrough. In certain examples, the support portion 112 has a circular transverse cross-sectional shape prior to installation of the crimp sleeve 160.

In certain implementations, the support portion 112 defines a strength member retention region 113 and a cable jacket retention region 117. The cable jacket retention region 117 is disposed between the strength member retention region 113 and the second axial end 116 of the plug connector 110. In certain examples, the strength member retention region 113 and the cable jacket retention region 117 cooperate to extend along an axial length of the anchor region 115 of the plug connector 110. In certain implementations, the support portion 112 has a first transverse cross-dimension CD1 (e.g., diameter) at the strength member retention region 113 and a second transverse cross-dimension CD2 at the cable jacket retention region 117. The first transverse cross-dimension CD1 is larger than the second transverse cross-dimension CD2 (see FIG. 10).

As shown in FIG. 3, the strength members 156 of the cable 150 extend along both the strength member retention region 113 and the cable jacket retention region 117. In certain examples, the jacket 158 of the cable 150 extends along only the cable jacket retention region 117. The smaller transverse cross-dimension CD2 of the jacket retention region 117 accommodates the presence of the jacket 158 between the support portion 112 and the crimp sleeve 160. The larger transverse cross-dimension CD1 of the strength member retention region 113 provides for a tight fit of the crimp sleeve 160 around the support portion 112 at the strength member retention region 113.

As shown in FIG. 10, each of the first interlock members 118 has an outwardly-facing surface 118a extending along the longitudinal axis 120 between opposite first and second ends. In certain examples, the outwardly-facing surface extends parallel to the longitudinal axis 120. A first transition surface 118b extends between the support portion 120 and the first end of the outer surface 118a. A second transition surface 118c extends between the support portion 120 and the second end of the outer surface 118a. In certain examples, the transition surfaces 118b, 118c extend transverse to the longitudinal axis 120.

As shown in FIG. 3, each of the second interlock members 168 has an inwardly-facing surface 168a extending along the longitudinal axis 120 between opposite first and second ends. In certain examples, the inwardly-facing surface 168a extends parallel to the longitudinal axis 120. A first transition surface 168b extends to the first end of the inner surface 168a. A second transition surface 168c extends to the second end of the outer surface 168a. In certain examples, the transition surfaces 168b, 168c extend transverse to the longitudinal axis 120. In certain examples, portions of the transition surfaces 168b, 168c of the second interlock members 168 extend along portions of the transition surfaces 118b, 188c of adjacent ones of the first interlock members 118.

As shown in FIG. 3, the outer surfaces 118a and transition surfaces 118b, 118c of the first interlock members 118 each form friction surfaces for retaining the surrounding portion 154 of the cable 150. The inner surfaces 168a and transition surfaces 168b, 168c of the second interlock members 168 each form friction surfaces for retaining the surrounding portion 154 of the cable 150. Accordingly, the surrounding portion 154 of the cable 150 is frictionally retained not only along the first interlock members 118, but also along the second interlock members 119. Further, in certain examples, the surrounding portion 154 of the cable 150 is frictionally retained not only along the outer-or inner-most surfaces 118a, 168a of interlock members 118, 168, but also along at least parts of the transition surfaces 118b, 118c, 168b, 168c of the interlock members 118, 168.

The first interlock members 118 each have respective axial lengths (e.g., axial lengths AL1, AL3) extending along the longitudinal axis 120. In some examples, the first interlock members 118 have a common axial length. In other examples, the axial length varies amongst the first interlock members 118. The gaps 119 extending between the first interlock members 118 each have respective axial lengths (e.g., axial lengths AL2, AL4). In some examples, the gaps 119 have a common axial length. In other examples, first interlock members 118 are spaced at different distances apart. The axial length AL2, AL4 of the gap 119 between two interlock members 118 is larger than the axial length AL1, AL3 of either of the two interlock members 118. In certain implementations, the axial length AL1 of each of the first interlock members 118 disposed along the strength member retention region 113 is larger than the axial length AL3 of each of the first interlock members 118 disposed along the cable jacket retention region 117.

In certain implementations, the ribs 218, 228 of the die pieces 202, 204 are sized to fit within the gaps 119 while accommodating the thickness of the crimp sleeve 160 disposed between the ribs 218, 228 and the bounding first interlock members 118. In certain examples, each rib 218, 228 has a width that is no more than 0.75 times the axial length AL2, AL4 of the respective gap 119. In certain examples, each rib 218, 228 has a width that is no more than 0.5 times the axial length AL2, AL4 of the respective gap 119.

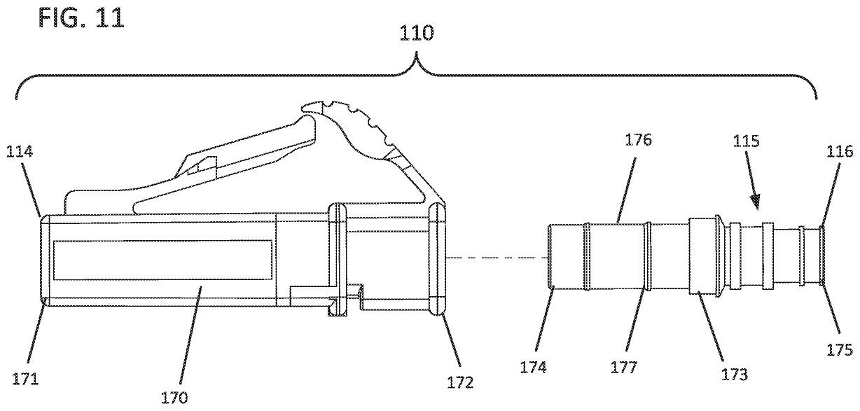

In accordance with certain aspects of the disclosure, the plug connector 110 is made from multiple separate pieces. For example, FIG. 11 shows an exploded view of an example plug connector 110 including a plug body 170 and a rear body 173 that couple together to form the plug connector 110. The plug body 170 defines the plug region 113 of the plug connector 110. The rear body 173 defines the anchor region 115 of the plug connector 110. In certain examples, a spring may be captured between the plug body 170 and the rear body 173 (e.g., to bias the carrying member towards a plug end face). In certain implementations, the rear body 173 is assembled to the plug body 170 before the cable 150 is anchored to the plug connector 110.

The plug body 170 extends between a first end 171 and an opposite second end 172. The rear body 173 extends between opposite first and second ends 174, 175, respectively. The first end 174 of the rear body 173 couples to the second end 172 of the plug body 170. In certain implementations, the rear body 173 includes an insertion portion 176 at the first end 174 of the rear body 173. The insertion portion 176 may be inserted inside the plug body 170 through an opening at the second end 172. In certain implementations, the first end 174 of the rear body 173 snap-fits (e.g., latches) within the plug body 170. For example, barbs 177 at the insertion portion 176 may engage catch surfaces within the plug body 170.

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

1. A fiber optic connector comprising:
a plug connector extending along a longitudinal axis between a first and a second end, the plug connector including a support portion towards the second end and a series of first interlock members protruding outwardly from the support portion, the first interlock members being spaced from each other along the longitudinal axis by gaps, each of the first interlock members having an outer surface extending along the longitudinal axis between opposite first and second ends, a first transition surface extending transverse to the longitudinal axis between the support portion and the first end of the outer surface, and a second transition surface extending transverse to the longitudinal axis between the support portion and the second end of the outer surface;
an optical cable including an optical fiber and a surrounding portion, the optical fiber extending through the second end of the plug connector to the first end so that an end face of the optical fiber is accessible at the first end of the plug connector, the surrounding portion extending over the second end of the plug connector; and
a crimp sleeve disposed over the second end of the plug connector so that the surrounding portion of the cable extends between the crimp sleeve and the first interlock members, the crimp sleeve including second interlock members extending radially into the gaps between the first interlock members to sandwich the surrounding portion therebetween.

2. The fiber optic connector of claim 1, wherein the surrounding portion includes strength members.

3. The fiber optic connector of claim 1, wherein the surrounding portion includes a cable jacket.

4. The fiber optic connector of claim 1, wherein each of the first interlock members of the rear body has a rectangular cross-sectional profile.

5. The fiber optic connector of claim 1, wherein the support section defines a strength member retention section and a jacket retention section disposed between the strength member retention section and the second end of the plug connector, the jacket retention section having a reduced transverse cross-section compared to the strength member retention section.

6. The fiber optic connector of claim 1, wherein each of the second interlock members extends along a majority of an axial length of the respective gap.

7. The fiber optic connector of claim 1, wherein each of the second interlock members has an exterior surface defining a depression having a rectangular cross-dimension.

8. The fiber optic connector of claim 1, further comprising an optical ferrule carried by the plug connector, the optical ferrule supporting the optical fiber.

9. The fiber optic connector of claim 1, wherein the optical fiber is one of a plurality of optical fibers of the optical cable, wherein each of the optical fibers extends through the plug connector so that respective end faces of the optical fibers are accessible at the first end of the plug connector.

10. The fiber optic connector of claim 1, wherein the plug connector includes a plug body and a rear body, the plug body defining the first end of the plug connector and the rear body defining the second end of the plug connector, wherein the support portion is defined by the rear body.

11.-16. (canceled)

17. A plug connector comprising:
a plug body extending between a first and a second end, the plug body being configured to receive an optical fiber; and
a rear body extending along a longitudinal axis between a first and a second end, the rear body including an insertion portion at the first end and a support portion at the second end, the support portion defining a jacket retention section and a strength member retention section that is disposed along the longitudinal axis between the insertion portion and the jacket retention section, the strength member retention portion having a transverse cross-dimension that is smaller than a transverse cross-dimension of the insertion portion, and the jacket retention section having a transverse cross-dimension that is smaller than the transverse cross-dimension of the strength member retention section, the rear body including first and second ribs extending radially outwardly from the strength member retention section, the first rib being axially spaced from the second rib by a gap, the gap being larger than an axial width of the first rib and being larger than an axial width of the second rib.

18. The plug connector of claim 17, wherein the axial width of the first rib is the same as the axial width of the second rib.

19. The plug connector of claim 17, wherein the rear body including third and fourth ribs extending radially outwardly from the jacket retention section, the third rib being axially spaced from the fourth rib by a second gap, the second gap being larger than an axial width of the third rib and being larger than an axial width of the fourth rib.

20. The plug connector of claim 19, wherein the axial width of the third rib is the same as the axial width of the fourth rib.

21. The plug connector of claim 19, wherein the axial widths of the first and second ribs of the strength member retention section are larger than the axial widths of the third and fourth ribs of the jacket retention section.

22. The plug connector of claim 19, wherein the second rib of the jacket retention section is axially spaced from the first rib of the strength member retention section by a third gap that is larger than the axial width of the second rib of the jacket retention section and is larger than the axial width of the first rib of the strength member retention section.

23. The plug connector of claim 17, wherein each of the first and second ribs has a flat outer surface extending parallel to the longitudinal axis.

24. The plug connector of claim 23, wherein sides of the first and second ribs extend transverse to the longitudinal axis to form forward and rearward facing shoulders.

25. The plug connector of claim 19, wherein each of the third and fourth ribs has a flat outer surface extending parallel to the longitudinal axis.

26. The plug connector of claim 25, wherein sides of the third and fourth ribs extend transverse to the longitudinal axis to form forward and rearward facing shoulders.

27. The plug connector of claim 17, further comprising a cable including a carrying member that extends through the rear body and through the plug body so that an end of the carrying member is accessible at the first end of the plug body.

28. The plug connector of claim 27, wherein the carrying member includes an optical fiber.

29. The plug connector of claim 27, wherein the carrying member includes a conductive wire.

30. The plug connector of claim 27, wherein the carrying member is one of a plurality of carrying members of the cable, wherein at least some of the carrying members are terminated at the plug body.

31. A method of terminating an optical cable at a fiber optic connector, the optical cable including an optical fiber surrounded by a jacket and strength members, the fiber optic connector including a plug body and a rear body, the method comprising:
positioning the cable at a second end of the rear body including routing the optical fiber through a passage defined in the rear body and routing the strength members over an exterior of the second end of the rear body so that the strength members extend across a series of flattened structures protruding radially outwardly from the exterior of the rear body;
positioning a crimp sleeve over the strength members at the second end of the rear body;
positioning the second end of the rear body and the crimp sleeve within a crimping station of a die set including aligning an edge of the crimp sleeve and the second end of the rear body at a stop surface defined by the die set so that a plurality of raised ribs at the crimping station align with gaps between the series flattened structures on the rear body; and
crimping the crimp sleeve using the die set including forming a series of interlocks between the crimp sleeve and the flattened structures of the rear body.

32. The method of claim 31, wherein the raised ribs of the die set include flattened surfaces facing the crimp sleeve.

33. The method of claim 31, further comprising routing a jacket of the cable over the second end of the rear body so that the jacket extends over at least some of the flattened structures of the rear body.

34. The method of claim 33, wherein the jacket extends over only a portion of the flattened structures of the rear body.

35.-41. (canceled)
